(19) United States
(12) Patent Application Publication
(10) Pub. No.: US 2004/0056849 A1
(43) Pub. Date: Mar. 25, 2004

(54) Method and apparatus for powering, detecting and locating multiple touch input devices on a touch screen

(76) Inventors: Andrew Lohbihler, North York (CA); Denny Jaeger, Oakland (CA)

Correspondence Address: Harris Zimmerman, Law Offices of Harris Zimmerman, Suite 710, 1330 Broadway, Oakland, CA, 94612-2506, US

(21) Appl. No.: 10/672,111

(22) Filed: Sep. 26, 2003

Related U.S. Application Data
(63) Continuation-in-part of application No. 10/207,716, filed on Jul. 25, 2002.

(51) Int. Cl. G09G 5/00

(52) U.S. Cl. 345/173

(57) ABSTRACT

A method for powering one or more touch input devices on a touch screen employs an EM standing wave propagating through a conductive surface layer of the touch screen to deliver power to the input devices without resorting to tether wires for any purpose. The input devices emit CDMA signals that are received by corner sensors in contact with the conductive layer and processed to detect, identify and locate the input devices. The EM standing wave is also used as a signaling medium to transmit multiple CDMA coded signals, and a synchronizing signal sent through the EM standing wave may control the timing of coded signals transmitted from the touch screen input devices to manage multiple device signals.

### CROSS-REFERENCE TO RELATED APPLICATIONS

This application is a continuation-in-part of U.S. patent application Ser. No. 10/207,716, filed: Jul. 25, 2002, for which priority is claimed.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to touch detection provoking devices that are used in conjunction with a touch screen device and, more particularly, to an apparatus and method employing Spread Spectrum (SS) signal structures for the operation of one or more touch-input devices on a touch-sensing system.

2. Description of Related Art

A touch system consists of two parts, namely one or more touch-input devices and a touch-sensing architecture. These two parts themselves can consist of hardware and/or software structures to realize their functionality.

As used herein, a touch-sensing tablet (termed touch screen hereafter) can be regarded as a touch screen, a digitizer, a writing panel, a modified mouse pad, or the like. A touch-input device can be regarded as a stylus, a pen, a rotary knob, a mouse, a slider (fader), a joystick, and the like. The system operation is defined as, but not limited to, one or any possible combination of the following functionalities, namely a touch screen (or its equivalent) that identifies, tracks, or communicates with one or more touch-input devices.

Touch screen technologies known in the prior art are most easily differentiated according to their system infrastructures. They are traditionally classified into resistive, or pressure sensing; capacitive; surface acoustic wave; ultrasound; and electromagnetic (EM) wave systems. The touch screen technologies of concern here are capacitive and direct-contact touch screens which only involve a form of electrical contact with the touch surface.

In capacitive systems, the screen assembly includes a sensing layer that is capable of storing electrical charges. Electrical sensors located at the boundaries of the touch screen apply an electrical field that is distributed across the touch screen surface, forming, in effect, a distributed capacitor. In a passive touch, a human finger or a conductive device touches the screen and draws a current capacitively from the ITO which draws current conducting from the sensors. The differential in the current flows in the boundary sensors corresponds to the position of the touch on the screen. For this reason, passive capacitive touch screens do not work well, if at all, when used with a non-conductive device, such as a gloved hand or an electrically inert stylus. In an active capacitive system, an active device emits an excitation signal at the touch point, injecting current into the sensors, and the current is measured to determine the touch position. Active capacitive systems usually have an improved touch resolution over passive systems, due to the fact that an active device provides an improved Signal-to-Noise Ratio (SNR) compared to passive systems. Capacitive systems are very durable, with high screen clarity.

In direct-contact touch systems, the screen assembly includes a sensing layer that is an open conductive contact surface. Examples of this surface are a resistive Indium Tin Oxide (ITO), Tin Oxide (TO), or any other resistive non-transparent surface. Electrical sensors located at the boundaries of the touch screen are sensitive to electrical energy coming in contact with the surface thereby applying a signal received at each of the sensors. The surface is initially at ground potential and an electrically charged stylus supplies current is drawn from the stylus to the contact surface. The differential in the voltage levels in the boundary sensors corresponds to the position of the touch on the screen. Similar to capacitive, direct-contact touch screens do not work well, if at all, when used with a non-conductive device, such as an electrically inert stylus. In an active direct-contact system, an active device emits an excitation signal at the touch point, injecting a signal into the ITO and received by the sensors, and the signal amplitude is measured to determine the touch position. Active direct-contact systems also have a high touch resolution, and are very durable, with high screen clarity. A direct-contact system can operate with low active voltages allowing methods for self-powering with EM fields (i.e. battery-free), and tether-free stylus operation (i.e. no ground cable). However, low voltage in a direct-contact system limits by the quality of the electrical contact between stylus and ITO causing degraded performance.

In the prior art, the number of touch-input devices allowed in a touch system is generally limited to one. However, in U.S. Pat. Nos. 6,005,555, 6,020,849, and other similar patents, methods of operating multiple touch-input devices are addressed, with each device designed to work on single or multiple narrowband channels.

Concerning information encoding, U.S. Pat. No. 5,247,138 describes a cordless digitizer stylus that transmits encoded signal to a touch-sensing tablet. This signal contains information bits relating to the touch-input device such as on-off status of the switches, position of the device, etc. These information bits are coded by a binary code at a particular frequency, and the information carrying signal disclosed is a narrowband signal.

In U.S. Pat. No. 6,005,555, a touch system with two carrier frequencies f₀ and f₁ is disclosed. Information bits of the system are commands from the touchsensing tablet to the touch-input devices and data bits from the devices to the tablet. The system signal spectrum consists of two discrete information spectra, centered at two carrier frequencies f₀ and f₁. No signal with bandwidth wider than the information bandwidth is used. Similar disclosures can be found in other patents regarding touch screens.

In U.S. patent application Ser. No. 09/877,611 the concept of Code-Division Multiple-Access (CDMA) signaling is used to describe how a plurality of devices can be simultaneously used on a touch screen surface, allowing all devices to be separately locatable. This disclosure discusses the use of CDMA applied to capacitive and direct-contact touch systems (and other touch systems such as acoustic, ultrasonic surface wave, EM, etc.) where a plurality of electrical contact devices are locatable on a touch surface.

It should be emphasized that touch systems of the prior art, including the above mentioned patents, are regarded as narrowband systems. That is, these systems have a signal bandwidth no wider than the information bandwidth. There is no wideband encoding for the system information bits or carriers in these patent disclosures.

In summary, the signal spectra of the above mentioned narrowband systems are the combination of the discrete information spectra at individual carrier frequencies. Their signal energy is confined within these discrete information spectra. No extra bandwidth other than the information spectra is occupied. These narrowband systems are significantly different from wideband systems, namely spread spectrum (SS) systems, of this invention.

A key performance parameter of any interface device, particularly to position high speed motion to a computer and display monitor, and the like, is the XY coordinate data rate and the speed of data transferred from the touch screen device to the conductive layer. It is therefore important to maximize the rate at which XY data is calculated and also to maximize the transfer of high-speed communication of serial data at the same time.

Accordingly, there is a need in the art for systems and methods that increase the rate at which data may be transferred in a communication system using spread spectrum techniques to communicate data between a device and the touch screen sensing system. The need for a device to have a data link varies significantly in data rate. Examples range from mouse clicks to a telemetry data channel. There is a still further need for systems and methods that increase the rate at which XY data may be calculated for multiple devices in an interface using spread spectrum techniques. Spread spectrum techniques help by allowing multiple devices to operate virtually simultaneously as long as processing methods occur in parallel, and provide processing gain for low power signals.

Other patent of interest include U.S. Pat. No. 6,570,541 to Dettloff, which describes systems and methods for wirelessly projecting power using multiple in-phase current loops. U.S. Pat. No. 6,525,648 to Kubler et al describes audio frequency identification systems and methods for waking up data storage devices for wireless communication. U.S. Pat. No. 6,512,478 to Chien describes location position system for relay assisted tracking. U.S. Pat. No. 6,483,427 to Werb describes a related article tracking system, and U.S. Pat. No. 6,388,628 to Dettloff et al teaches systems and methods for wirelessly projecting power using in-phase current loops. U.S. Pat. No. 6,353,406 to Lanzi et al details a dual mode tracking system.

These patents are related because of their use of RFID technology and methods of powering them remotely using EM fields. If tracking is mentioned it is in the context of using spread-spectrum codes to modulate and estimate the direction of arrival of the radio signal from an RFID in short range. None of these patents discuss a method of wireless surface EM conduction powering of devices. None of these patents discuss the use of RFID in a pen-based system for short range location on touch based systems, or the like.

### BRIEF SUMMARY OF THE INVENTION

The present invention generally comprises a method for powering multiple touch devices on a touch screen. It further includes a method for signaling the devices on the surface of a touch screen as a means of detecting the touch-point position of each device in two-dimensions.

In one aspect the invention uses an EM standing wave propagating through a conductive surface layer of a touch screen to deliver power to touch screen devices without resorting to tether wires for any purpose (such as for powering and/or grounding). EM energy is provided by direct contact with a powering field applied directly to the conductive layer from an EM oscillator source. The touch devices do not require any other means of powering up for their operation.

Another aspect of this invention is the use of a hand-ground method of providing a ground reference to the device electrical circuit essentially allowing it to power-up. (Although the human hand is mentioned as the body portion that provides the grounding contact, it may be appreciated that any part of the body may provide this function.)

A further aspect of this invention is the dual use of an EM standing wave both for powering touch screen input devices, and as a signaling medium. Signals from the touch screen input devices are picked-up by corner sensors in contact with the conductive layer of the touch screen, and processed to detect and locate the input devices. The invention is capable of powering and tracking multiple devices on the conductive layer. A more specific aspect of this invention is the provision of a synchronizing signal sent through the powering EM standing wave for the purpose of controlling the timing of coded signals transmitted from the touch screen input devices to manage multiple device detection.

### BRIEF DESCRIPTION OF THE DRAWING

FIG. 1 depicts multiple touch screen input devices being detected and located on a touch screen assembly.

FIG. 2 depicts a powering field as an EM standing wave being emitted into a conductive surface layer at 4 corners thereof.

FIG. 3A depicts a stylus device touching the conductive layer using a hand-ground allowing the system to operate without any tether wires and free of surface contact interference.

FIG. 3B depicts a stylus device touching the conductive layer using a hand-ground but also including surface contact interference.

FIG. 4 shows the detailed circuit schematic for a touch input device circuit.

FIG. 5 illustrates the power waveform of a touch input device using the positive mode of the EM standing wave for power, and using the negative mode of the EM standing wave for signaling device identification.

FIG. 6 shows a detailed schematic of the analog signal processing circuit for each corner sensor.

FIG. 7 is an illustration as in FIG. 5, depicting powering multiple touch input devices with the positive EM wave, and device signal summing on the negative EM wave.

FIG. 8A depicts an arrangement for data switching using CDMA codes; FIG. 8B depicts a code inversion technique for transmitting a switch condition.

FIG. 9A depicts a functional block diagram of a method for synchronizing touch input devices using a modified powering signal; FIG. 9B depicts the synch signal.

### DETAILED DESCRIPTION OF THE INVENTION

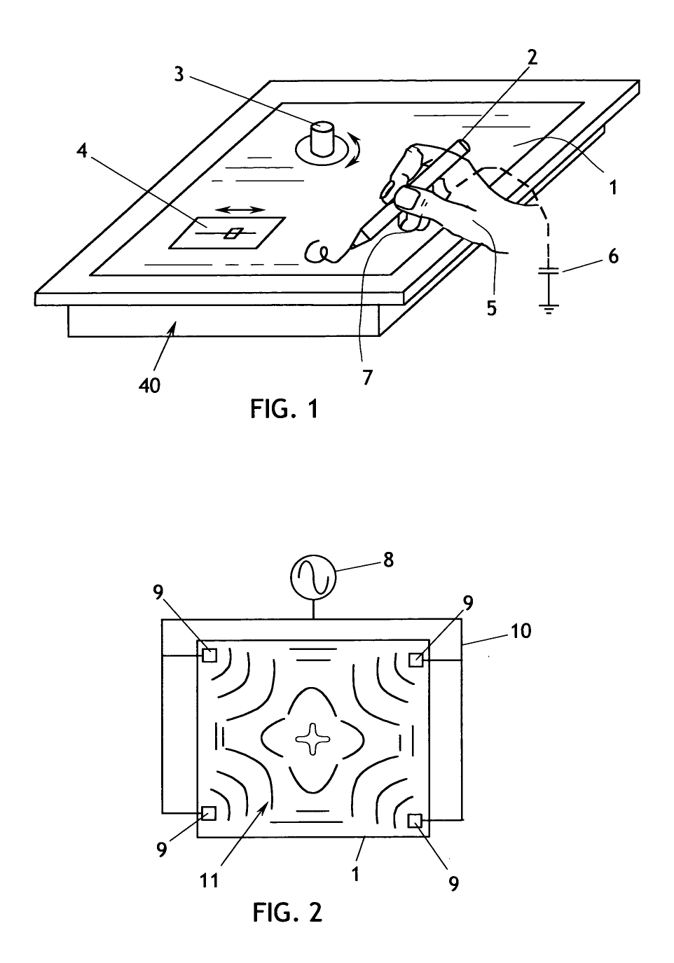

The present invention generally comprises a method and apparatus for powering, detecting, and tracking (continuously locating) touch screen input devices. With regard to FIG. 1, the invention generally includes a plurality of touch screen input devices such as a pen/stylus 2, a knob 3, and a fader 4, any or all of which are temporarily or permanently secured to a touch screen assembly 40. A conductive layer 1 is provided at the exterior of the touch screen assembly 40, and is preferably transparent to enable unimpeded visualization of the output of the display portion of the assembly 40 that underlies the conductive layer 1. One such material is an indium-tin oxide coating or layer or film commonly known in the prior art.

A salient aspect of the invention is the provision of an EM standing wave in the conductive layer 1 to transmit operating power to the touch screen input devices 2-4. The EM standing wave provides a tether-free power source to each input device. Tether-free is used herein to indicate there is no powering cable or ground cable, nor any other kind of wired attachment to the touch input devices. The input devices are electrically independent of any other power circuit and are powered only by the touch-point of each device touching the EM electrified surface 1, and by the human hand 5 holding the device and touching the electrical ground 6 of the device. For example, the knob device 3 can also be similarly powered because the device 3 is in contact with the surface 1 at all times and absorbs the EM field energy. These devices include a circuit for picking up the EM field energy (for example at 13.56 MHz or any other relevant EM frequency between 100 kHz and 10 GHz). Any high frequency in the MHz band will do as an EM field, but the ideal frequency should be higher than the highest spectral component of the DSSS spreading code used in the devices (penstylus/knob/fader) to avoid interfering with the code spreading function. The ideal EM field frequency should be low to be an efficient power source to said devices.

For EM field powering the surface 1 is powered via direct electrical contact 10 with the output of an EM oscillator 8 that supplies the EM voltage to the wires 10 connected to the corners 9 of the conductive layer 1, as shown in FIG. 2. This symmetric application of the powering signal allows the EM standing wave 11 to conduct on the surface 1 as a uniform standing wave that is generallysymmetrical to the corners of the area. Depending on the degree of surface resistivity, the surface 1 will partially attenuate the EM field powering signal causing a reduction in the amplitude of the powering signal toward the middle of the surface 1. If the amplitude reduction is small, all devices can still be powered up without loss of powering function over the entire area of device powering surface 1. Engineering is required to ensure that the powering field has sufficient powering and amplitude signaling bandwidth over the whole area, with respect to the number of devices being powering and positioned. Note that the EM standing wave in the conductive layer 1 is not designed nor intended to radiate energy to the surrounding area.

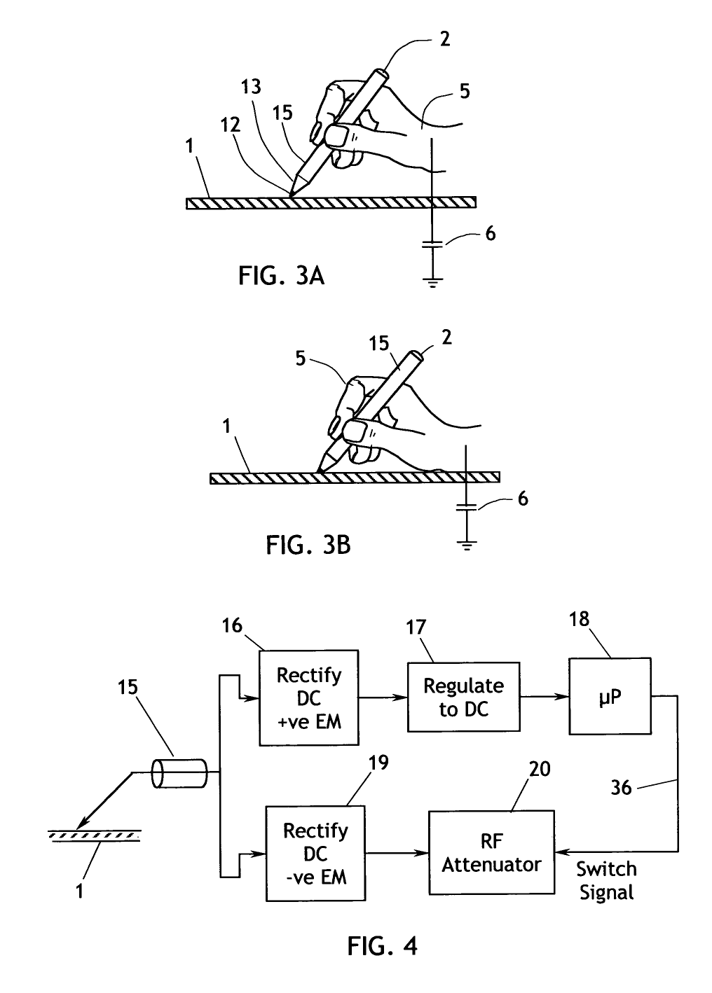

All the touch input devices are powered by the EM field, and it is desirable but not necessary to have a hand-ground reference 6 present. The hand circuit in FIG. 3A requires that a touch input device has a touch-point 12 that is electrically insulated by tip 13 from the hand-grounded tubular body 15. In this manner the device will allow EM energy to be input to the pen 2 and rectified (step 16) for DC conversion (see FIG. 4) such that the hand-ground allows a stable DC potential difference to form and be regulated (step 17) to power the device microprocessor (μP) 18.

The tether-free operation of the pen relies in part on the high impedance between the high-frequency AC EM field source and a human-hand ground reference 6. The human hand is not a typical conductor but the human body is a capacitor and is capacitively coupled with ground 6. The EM field standing wave on a surface such as ITO does not attenuate when the hand 5 touches the AC power source because the AC impedance is high, contrary to the impedance of a low frequency AC EM field source or DC current. For that reason, resting the hand on the conductive surface 1, as shown in FIG. 3B, will not cause the AC power amplitude to attenuate. This effect allow the power signal to exist on the surface 1, and the hand 5 can rest on the surface in a natural writing position without causing any EM field amplitude loss on the surface 1.

The touch input devices all derive operating power based on the electronic principle that the AC signal can be rectified into a DC signal inside the device. FIG. 4 shows the schematic of the pen 2 device circuit, which is similar to the other touch input devices. The pen tip 12 directly touches the surface of the conductive surface 1 allowing the EM powering signal 11 to be conducted directly into the pen. The signal 11 is positively rectified (16) to produce a DC signal proportional to the amplitude of the input signal. The DC signal is applied to a voltage regulator 17 to control the DC voltage output fed to the microprocessor (μP) 18. The processor is typically required to output a consistent data signal code 36 and therefore the operating voltage must be controlled to the μP operating range. When the μP 18 is powered sufficiently, it will start sending out the pulsed code 36 that will power an attenuator 20. The attenuator 20 is designed to attenuate the negative portion of the rectified EM powering signal output from a negative signal rectifier 19. The purpose of this arrangement is to use the negative component of the EM field as a non-corruptible medium independent of the powering field, and with sufficient signal bandwidth to send a plurality of device signals back through the surface 1. Thus the EM standing wave provides a communications medium from the devices to the screen sensors, in addition to providing power to operate the touch input devices.

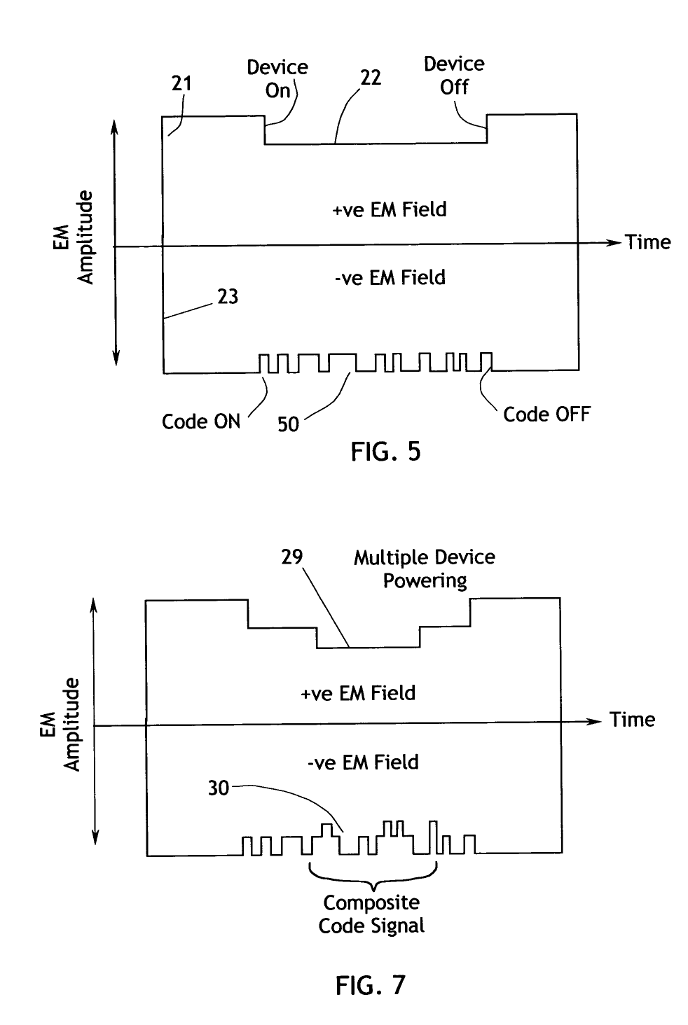

FIG. 5 shows the operation of powering and signaling for a single touch input device. The return signals 23 in the negative EM field are independent of fluctuations 22 in the powering amplitude caused by device powering, as shown in FIG. 5, where the Device On period 22 causes a slight drop in the positive voltage level, but the negative voltage signal (the coded return signals from the touch input device) is relatively unaffected. Typically the attenuator 20 can be operated to be switched-off when the μP output signal is low, but be switched-on and apply a reduction in EM signal strength (about −10 dB) when the μP output signal 36 is high. In this manner the signal response in the EM return signal 23 is immediate and hence a step or pulse signal output 23 is evident at the corner sensors 9. Also, the quality of the coded return signal 23 will not degrade as the signal travels through the conductive layer because it is modulated with the EM field and maintains a high impedance with any capacitive and resistive interference on the layer 1.

The direct conduction of the metallic device powering contact 12 with the layer 1 must be a low impedance contact to allow EM energy 11 to be conducted into the pen. After the EM energy is positively rectified 24, the resulting signal will become a powering DC component relative only to the “hand-ground” reference. The powering of the touch input devices is dependent on a hand-ground reference where the human body acts as an electron reservoir and is capacitively coupled to ground 6. In this design the current flows from the corners to the pen such that the EM field is loaded and attenuated in the pen and ultimately flows out through the hand-ground (i.e. through the human body of the hand holding the pen) to complete the circuit.

Once the pen is fully powered and operational, the code return signal 50 is sent from the touch input device through the layer 1 only by altering the negative amplitude 23 of the EM standing wave (see FIG. 5). The return signal is directly related to the μP code and attenuates the EM negative signal 23 as the code goes high, and does not affect the EM as the code is low, thus defining the code segment 50. Depending where the pen touches the conductive layer 1 the amplitude of the return signal sent to the corner sensors 9 will be proportional to the degree of resistivity of the layer 1. This effect is due to fact that the return signal amplitude is reduced by the length of the resistive path from the pen to each corner sensor 9.

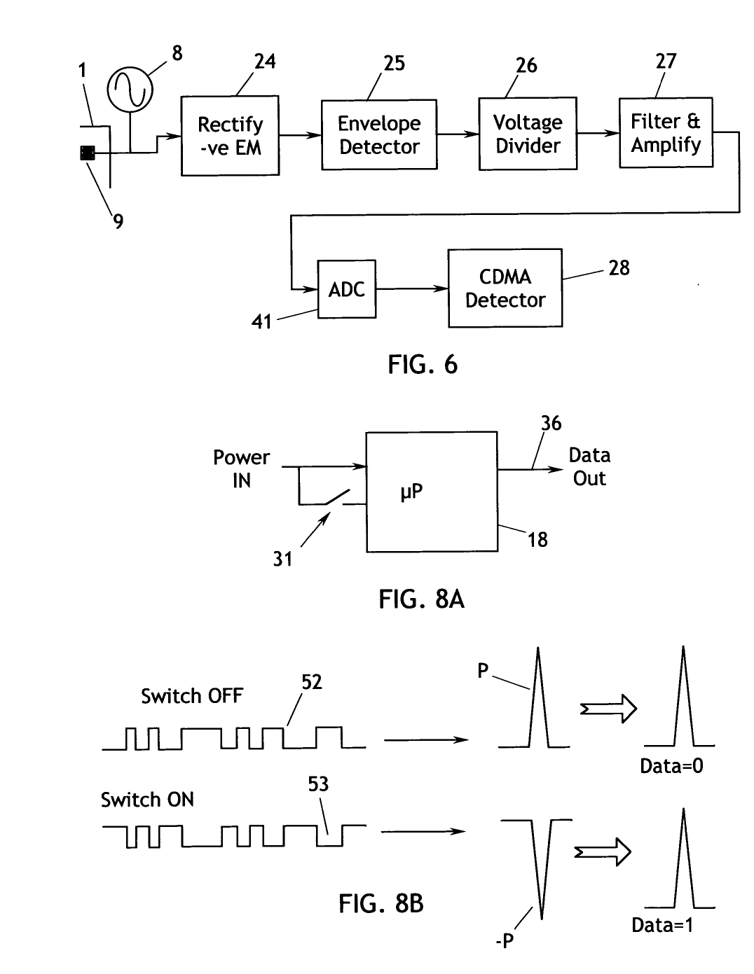

FIG. 6 shows the sensor channel circuit for detecting and processing the output signals. The output signal is received at the corner sensor 9 and a rectifier 24 negatively rectifies the signal to separate the return signal from device powering transients on the positive EM wave. An envelope detector 25 removes the EM wave frequency leaving only the code attenuated CDMA signals from the device(s). A voltage divider 26 ensures that the output signal amplitude is proportional to the resistive path length to accurately position the device. After filtering and amplification 27 to shape the pulsed code and fit it within the sensing range of an Analog-to-Digital Converter (ADC) 41, the output signal is digitized in the ADC 41 and sent to the CDMA detector 28 for device detection, identification, and the calculation of positioning coordinates.

Another useful feature of the method of the invention is that the output signal supports the use of “signal summing” when multiple devices are used on the touch screen. That is, when multiple devices are powered and simultaneously activating the code attenuators in more than one device, the output signal is the algebraic sum of the individual returns signals produced by each device's attenuation code. This feature allows the CDMA codes for each pen to be simultaneously decodable and each device is simultaneously locatable on the surface 1. FIG. 7 shows the operation of EM powering and signaling in the EM field wave for two devices. Multiple devices when powered will create a “composite” return code signal 30 that are independently decodable in the CDMA detector 28. This feature of CDMA is non-synchronous because a synchronizing timing signal is assumed to be not available to instruct the device when to start transmitting the CDMA codes. (In synchronous CDMA a synchronizing signal would be transmitted to individual devices as a code start trigger signal followed by a delay controlled by the said synchronization signal.)

To enable the EM field powering method to support multiple devices, the EM powering signal must have: 1) bandwidth to power multiple devices, and 2) bandwidth to allow multiple attenuator signals to be received and decoded by the CDMA detector. This is generally accomplished by ensuring sufficient amplitude in the EM powering wave on the surface 1, thus allowing enough voltage to power multiple devices on the positive EM field, and simultaneously allowing enough bandwidth for multiple devices to signal on the negative EM field portion. For example, a powering signal with a minimum 30-volt amplitude on layer 1 can power as many as 15 devices simultaneously (on the positive side), and simultaneously support the combined return signals of these 15 devices on the negative side (see FIG. 7).

Furthermore, in order to generate an acceptable composite return signal 30 that allows all multiple devices to be separately and accurately locatable, the composite signal must have the following characteristics:

1) Sufficient analog-to-digital conversion (ADC) resolution to locate a device over the XY plane of interest (typically 12, 14, or 16-bit resolution),

2) Must be engineered to operate entirely within bounds of the ADC signal input range (to avoid getting the signals “clipped”).

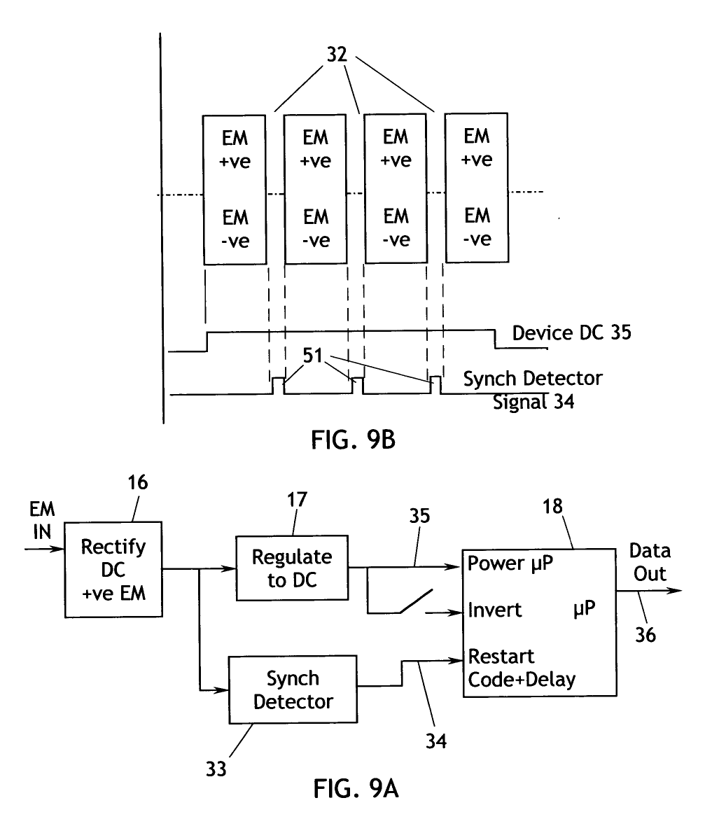

Another important feature of the invention is the provision of a synchronizing signal embedded in the EM powering signal, so that individual touch screen input devices can detect a synch-trigger and be activated to start transmitting a CDMA identifying code after a delay time. FIG. 9 depicts a method for applying timed pulses 51 in the EM field, in which the EM field 21 is embedded with the synchronization signal 51 comprised of the EM field powering signal switched-off for a short time 32. In the device, the DC regulator 17 will not respond to the synch signal. However, the synch detector 33 will recognize the synch trigger and send it to the μP 18. The synch signal pulse (when high) will trigger the μP 18 to start the CDMA code transmission of the respective touch screen input device after a programmed delay. The advantage of this approach is to permit the use of multiple devices within a specific composite signal range, allowing more devices to be simultaneously detectable and accurately locatable. Using this approach various timing schemes can be employed to independently track devices without stringent engineering rules applied to the composite signal.

Another advantage of this method is that the CDMA detector 28 uses a matched-filter algorithm M_{mf} such that a code for each device “j” is correlated with the signal received at each corner sensor 9 “i” and outputs the correlation peak amplitudes P_{i,j} as shown in equation (1). The matched filter algorithm is typically a convolution function implemented digitally and in various methods, and is used here to correlate a sensor input with a known code. The most compact method of implementation is known as the transposed FIR method of doing matched filtering. If all of the P_{i,j} exceed a threshold for device “j” then that device is detected, and hence the device coordinates Xⱼ, Yⱼ may be calculated to position the device “j” as shown in equations (3) and (4). The function Sⱼ calculated in equation (2) is used to normalize the position calculation to remove scaling effects and improving the device positioning accuracy.

P_{i,j}(t)=M_{mf}(Sᵢ(t),Cⱼ(t)), (1)

Sⱼ(t)=P_{1,j}(t)+P_{2,j}(t)+P_{3,j}(t)+P_{4,j}(t) (2)

Xⱼ(t)=((P_{1,j}(t)+P_{4,j}(t))−(P_{2,j}(t)+P_{3,j}(t)))/Sₜ(t) (3)

Yⱼ(t)=((P_{1,j}(t)+P_{4,j}(t))−(P_{3,j}(t)+P_{4,j}(t)))/Sₜ(t) (4)

In the above equations, the two-dimensional coordinates XY can be determined using a minimum of 4 sensors signals. It is possible to use more than four sensor channels on any shaped plane of continuous conductive material and reformulate the equations to calculate a device position coordinate.

Furthermore, a CDMA code can be used to convey a binary communication link between the device and the CDMA detector 2. As shown in FIG. 8A, one or a plurality of devices 2, 3, 4 have switches 31 to convey switch event data to the CDMA detector 28. Binary switch events (e.g. like a right or left mouse click) can be conveyed in the CDMA signal using bit-inversion modulation. For example, in FIG. 8B the code pulses 52 during a switch OFF condition are not inverted, and cause the output of pulse P which correlates with data=0. During a switch ON condition (mouse click and the like) the code pulses 53 are inverted with respect to pulse train 52, causing an output −P and a correlated data=1. The CDMA detector 28 thus recognizes the modulation as an inversion of the correlation peak P_{i,j} thereby allowing the CDMA detector to convey the event data as a sign change in the values of P_{i,j} as often as every code period. During bit-inversion modulation, the shape and amplitude of the correlation peak does not change allowing it to be used for device location after the “data-bit” of the switch-event is removed, as shown in FIG. 8B.

In the case where XY position is calculated to present device locations on a display area underlying the conductive layer 1 by the display unit 40 (such as an LCD screen or video monitor) a method is required to correct for position errors. A software algorithm is required to correct for inaccuracies of misalignment between the calculated coordinates of the position sensing system and the display coordinates, to rescale the active device operation area to the display area, or correct offset errors in the detector analog hardware. The algorithm can be executed separately for any device to eliminate accuracy differences between specific device types. The user is required to move a device to a minimum of two points on the lower left and upper right of the display area to “rescale” the reported coordinates to these points. Other methods require moving to a displayed grid of points in 2D space to provide more calibration detail.

The following software algorithm (equations (5) and (6)) can be used to correct position errors between the physical device location and the displayed device position. This position calibration method will correct various error sources caused by display misalignment, scale factor error of the active area to the display area, or offset and gain errors in the analog hardware. The user is required to touch the lower left and upper right display area to “rescale” the reported coordinates to these points. A calibration method with more than two calibration touch points would improve accuracy, and be based on a least-squares regression set of equations instead of equations (5) and (6).

X_{C}=R_{X}(X−X_{L})/(X_{U}−X_{L}) (5)

Y_{C}=R_{Y}(Y−Y_{L})/(Y_{U}−Y_{L}) (6)

Where:

X_{C}, Y_{C} are the corrected position coordinates

R_{X}, R_{Y} are the resolution limits of the X and Y axes

X_{L}, Y_{L} are the coordinates of the lower calibration point

X_{U}, Y_{U} are the coordinates of the upper calibration point

The display software of the XY positioning hardware 40 may also enable the system to designate selected areas on the XY screen for certain devices. This may be accomplished by reporting 2D device digitization points only in areas designated for pen sensing, and doing the same for other devices. This feature would be especially useful as a simple means of rejecting non-pen inputs in an area designated for handwriting only and other stylus-like input, and allow another devices like a knob/fader or even another stylus device to operate independently.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. In a touch screen assembly having at least one touch input device adapted to provoke a touch detection on a touch screen, the improvement comprising:
a conductive layer joined to said touch screen;
an RF generator connected to said conductive layer to create an EM standing wave in said conductive layer;
signaling means in said at least one touch input device for receiving power from said EM standing wave and emitting a device signal;
said touch screen assembly including detection means for receiving said device signal and determining the location of said at least one touch input device on said touch screen.

2. The touch screen assembly of claim 1, wherein said signaling means includes rectifying means for generating separate positive and negative waveforms.

3. The touch screen assembly of claim 2, said at least one touch input device including a voltage regulator to regulate said positive waveform and generate a power signal.

4. The touch screen assembly of claim 3, said at least one touch input device including a microprocessor powered by said power signal.

5. The touch screen assembly of claim 2, said at least one touch input device including an RF attenuator, said negative waveform being conducted to said RF attenuator.

6. The touch screen assembly of claim 5, said signaling means including means for driving said RF attenuator to produce a coded pulse train that comprises said device signal.

7. The touch screen assembly of claim 6, said at least one touch input device including a user-operated switch, and means for signaling operation of said switch.

8. The touch screen assembly of claim 7, wherein said means for signaling operation of said switch includes means for inverting said coded pulse train.

9. The touch screen assembly of claim 8, said touch screen assembly further including means for detecting said inverted coded pulse train and distinguishing operation of said switch.

10. The touch screen assembly of claim 1, wherein said device signal is a CDMA signal.

11. The touch screen assembly of claim 1, wherein said detection means includes a plurality of sensors connected to said conductive layer.

12. The touch screen assembly of claim 11, wherein each of said sensors is connected to sensor signal rectifier means for generating a negative waveform corresponding to the respective sensor signal.

13. The touch screen assembly of claim 12, wherein said negative waveform is conducted to an envelope detector to remove RF components of said negative waveform.

14. The touch screen assembly of claim 13, wherein the output of said envelope detector is connected to voltage divider means for normalizing the strength of the sensor signal.

15. The touch screen assembly of claim 14, wherein the output of said voltage divider means is connected to an analog/digital converter.

16. The touch screen assembly of claim 15, wherein the output of said analog/digital converter is conducted to CDMA detector means for detecting a CDMA code in the sensor signal.

17. The touch screen assembly of claim 6, further including a plurality of said touch input devices, each generating a respective coded pulse train that uniquely identifies the respective touch input device.

18. The touch screen assembly of claim 17, wherein said detection means includes means for receiving and detecting multiple coded pulse trains from said plurality of said touch input devices.

19. The touch screen assembly of claim 18, further including means for controlling said RF generator to add a synch signal to the output of said RF generator.

20. The touch screen assembly of claim 19, wherein said synch signal comprises at least one short-period interruption of said RF signal.

21. The touch screen assembly of claim 17, wherein said coded pulse trains comprise CDMA signals.

22. The touch screen assembly of claim 21, wherein said detection means includes matched-filter means for separating and detecting said CDMA signals of said plurality of touch input devices.

23. The touch screen assembly of claim 1, wherein a device power circuit is established by user touch applied to said at least one touch input device, said power circuit extending from said conductive layer through said at least one touch input device and thence through the body of the user to ground.

24. A method for operating a touch screen assembly that has a touch screen and at least one touch input device, including the steps of:
providing a conductive layer joined to the touch screen;
generating an EM standing wave in said conductive layer;
said at least one touch input device receiving a power signal from said EM standing wave and emitting a device signal;
said touch screen assembly receiving said device signal and determining the location of said at least one touch input device on said touch screen.

25. The method for operating a touch screen assembly of claim 24, further including the step of rectifying said power signal in said at least one touch input device to generate separate positive and negative waveforms.

26. The method for operating a touch screen assembly of claim 25, further including the step of rectifying the positive waveform to provide operating power to a microprocessor.

27. The method for operating a touch screen assembly of claim 25, further including the step of conducting the negative waveform to an RF attenuator, and driving said RF attenuator to produce a coded pulse train that comprises said device signal.

28. The method for operating a touch screen assembly of claim 27, further including the step of providing a user-operated switch in said at least one touch input device.

29. The method for operating a touch screen assembly of claim 28, further including the step of signaling actuation of said user-operated switch by inverting said coded pulse train.

30. The method for operating a touch screen assembly of claim 27, further including providing a plurality of said touch input devices, each generating a respective coded pulse train that uniquely identifies the respective touch input device.
